(19) United States
(12) Patent Application Publication
(10) Pub. No.: US 2008/0102181 A1
(43) Pub. Date: May 1, 2008

(54) Rejuvenation of used cooking oil

(76) Inventors: Ramu M. Rao, Baton Rouge, LA (US); Abdulrahman Foad Abdulfattah, Jeddah (SA); Abdo A. Husseiny, LaPlace, LA (US)

Correspondence Address: NIXON PEABODY, LLP, 401 9TH STREET, NW, SUITE 900, WASHINGTON, DC, 20004-2128, US

(21) Appl. No.: 11/588,428

(22) Filed: Oct. 27, 2006

(51) Int. Cl. C11B 5/00

(52) U.S. Cl. 426/542; 426/601

(57) ABSTRACT

Implements for decolorization, deodorization and deoxidization of used or filtered spent cooking oil are disclosed to improve on the service life of cooking oil and the health aspects of fried foods. This can be achieved on a small to large scale by simple implements filled with a mixture of plant-based granulated activated carbons and antioxidants, wherein the implements can be immersed in a frying appliance, such as a pot, a vat, a pan, a deep fryer and the like, containing used oil or in a storage unit of filtered oil. The overall safety, palatability and economics of a food preparation process are determined by the ease of oil containment and cleanup during and after frying with oil.

### BACKGROUND OF THE INVENTION

1. Field of the Invention

The invention relates generally to rejuvenation, or treatment, of used cooking oil, and more particularly, to the removal of odor, discoloration and oxidants caused by free fatty acids, oxidized fatty acids, and oxidation of food particulates in used cooking oil.

2. Description of the Related Art

Deep frying remains a popular method of preparing foods, such as poultry, fish, potatoes, and vegetables. Deep frying takes place in homes, cafeterias, restaurants, and throughout the food industry. In particular, deep fried foods are popular due to their distinctive flavor and aroma. This flavor and aroma depends on the quality of the frying oil, because fried foods partially absorb the frying medium. Thus, the quality of frying oils is important both to food consumers and to the food service industry.

While replacing the frying oil after a single use, or even after a few uses, may ensure the quality of the frying oil, economic considerations call for the repeated use of cooking or frying oil. Indeed, recovery of used cooking oil for repeated use is an established practice. For example, fast food establishments that use large quantities of oil for frying rejuvenate frying oil to permit repeated and cost-effective use of the oil.

On a greater scale, industrial frying of food items, such as those sold as pre-prepared meals, potato chips, pies, and the like, takes place on a mass production scale, where large quantities of cooking oils are heated in pans or vats to temperatures ranging from about 315° F. to about 400° F. (157-204° C.) or more. Large amounts of food are immersed in the same oil for cooking, carried through the hot oil via a conveyor, and subsequently prepared for packaging, shipping, and future consumption.

Maintaining cooking oil at such elevated temperatures for long durations in combination with the release of water from the food juices causes hydrolysis, which leads to the formation of free fatty acids (FFAs). In addition, oxidized fatty acids (OFA) are produced by oxidative degeneration of fats that result from contact between the hot oil and the air of the surroundings. An increase in FFAs decreases the oil's smoke point, and thus increases smoke during use as the oil ages. Furthermore, solid impurities, such as, small pieces and particulates of food, accumulate in the hot oil during the cooking process. Heating transforms oxidized fatty acids into secondary and tertiary by-products that cause off-flavors and off-odors in the oil and fried foods. Caramelization also occurs during the use of oil over an extended period of time. The color of the oil gradually darkens during the cooking process until it reaches a dark brown color, a precursor to rancidity. Cooking in used oils with a very dark color, combined with other by-products, produces dark and unappealing fried foods.

As oils are used in cooking, they tend to break down, degrade, and hydrolyze to free fatty acids, glycerol, and other polar products. A reliable indicator of the deterioration of frying oil is the level of FFA content, which increases with use as a result of hydrolysis of triacylglycerols as well as further decomposition of hydroperoxides during cooking. The FFAs are among the more harmful products of oil degradation, and the released fatty acids are more susceptible to thermal oxidation under frying temperatures than those esterified to glycerol. The oxidized products of fatty acids in the frying medium impart hydrolytic rancidity, indicated by off-flavors and off-odors, to the fried foods. Frying oil deterioration over time eventually can reach a rapidly accelerating, uncontrolled rate. The recommended maximum acceptable level for FFAs is three to four percent. Control of FFAs to about 0.4% may prevent acceleration of the break-down of frying oil fats.

Effective treatment of used cooking oil to overcome contamination involves removal of food particles, removal of phospholipids, deodorization and decolorization. A number of different processes have been developed for treating used cooking oil, but none of the processes to date have been sufficiently effective in treating all of the physical and chemical changes of used or spent cooking oil.

Generally, filtration is employed in the culinary industry to purify used cooking oils to prevent the build up of impurities in the oils. Improving the service life of cooking oil and the subsequent health aspects of fried foods may require frequent filtration treatments of frying oils to control build up of FFAs and remove insoluble particles. Typically filtration is accomplished by a paper or cloth filter that removes food bits and thereby reduces the chance of deleterious reactions caused by such materials in the oil. Filtration, however, is not sufficient for total recovery of used cooking oil, because the fried food may still pick-up an undesired odor and taste from the used cooking oil, dependent on the filter media. Hence, there is still a need to deodorize used cooking oil and to impart a desired flavor to products even if they are cooked with filtered used cooking oil.

Natural and synthetic adsorbents are also used to adsorb fat soluble degradation byproducts and remove insoluble particles. Natural adsorbents include attapulgites, bentonites, zeolites, active carbon, kaolin, active silica, diatomaceous earth, active alumina, and active magnesia. Synthetic adsorbents include blends of silicates, magnesium and aluminum oxides, and various silicates formed through fusing lime, magnesium, and aluminum oxides with diatomaceous earth. Typically dry adsorbent powders are dispersed in the fryer oil to form slurry and then circulated through a filter and returned back to the fryer until a filter bed or cake is established and the fryer is free of fines and particles. Subsequently, the cleaned frying oil is pumped back into the fryer.

A mixture of activated carbon and silica reduces acid value by 53.9% and photometric color of used frying oil by 38.3%, although stability of the fat may be affected. In addition, a mixture of 4.5% clay, 0.5% charcoal, 2.5% magnesium oxide, and 2.5% Celite significantly improves dielectric constant changes, FFAs, and color by 6%, 14%, and 58%, respectively. Although two antioxidants comprising 50 ppm butylated hydroxyanisole (BHA) and 1000 ppm ascorbyl palmitate (AP) and an antifoam agent comprising 10 ppm dimethylpolysiloxane can be added into the treated used fats, continued frying for additional 15 hours leads to greater deterioration of the used oil as compared to untreated oil samples. Fresh partially hydrogenated soybean oil used at a turnover rate of 5 hours is found to increase dielectric constant changes, FFAs, and color after 24 hours, much faster in treated oils than in untreated control oil samples.

Daily treatment of used frying oil by Frypowder, an adsorbent agent from porous rhyolite, citric acid and water which, is commercially sold by MirOil Corporation, Allentown, Pa., maintains levels of alkaline contaminant material relatively constant over days of cooking, and apparently reduces the color darkening and foaming tendency as well as formation of polar component, conjugation, and dielectric constant of frying oil during frying. However, Frypowder adsorbent agent does not adsorb fatty acids due to its natural acidic characteristic, which depends on the citric acid composition.

According to the guidelines of the FDA Food Safety and Inspection Service (FSIS) Meat and Poultry Inspection Manual, which regulates industrial fryers of meat and poultry, indicate that suitability of oils used for deep frying for further use can be determined from degree of foaming during use or from color, odor, and flavor. In addition, oil should be discarded when it foams over the vessel's side during cooking, or when its color becomes almost black as viewed through a colorless glass container. Large amounts of sediment and free fatty acid content in excess of 2 percent are usual indications that frying oils are unwholesome and require reconditioning or replacement. Industrial fryers of meat and poultry, in general, use the 2% FFA limit, or less if mandated by their customers, as their main specification for oil quality.

Furthermore, in the case of soybean oil, in particular, deodorization is performed during refinement for removal of odorous substances odor-bearing compounds such as aldehydes, ketones and hydrocarbons. Citric acid is usually added in order to chelate any metal ions which may catalyze peroxide formation. Freshly refined soybean oil is practically odorless and bland. However, objectionable off-flavor described as “green, grassy, fishy” develop quickly if the oil is heated (used in cooking and frying), exposed to light and oxygen, or contaminated with certain metals such as copper and iron during storage. The process is apparently triggered by the oxidation of the unsaturated fatty acids and most particularly linolenic acid. Unlike oxidative rancidity, off-flavor occurs in soybean oil at very low levels of oxidation and can not be retarded appreciably by antioxidants, but by minimizing exposure to oxygen (bottling under nitrogen) and to light (opaque containers, dark glass bottles). Accordingly, there is a special need for deodorizing soybean oil even after limited use.

U.S. Pat. No. 6,482,326 discloses a method of filtering spent cooking oil using a filter envelope including two panels with one panel formed from a filter pad with permeability greater than that of the second panel which is made from a filter paper, and may enclose a metal spacer grid. When the filter is connected to a pump for drawing the oil through the filter, the flow of the oil is directed selectively through the filter pad, whereby undesired materials are removed from the oil.

An adjustable continuous filtration system for cooking oils is disclosed in U.S. Pat. No. 5,846,409. Using a variable orifice restriction such as a valve, the amount of cooking oil recycled to a filter is controlled in accordance with the results of testing the discharged cooking oil for quality control, by changing the size of the orifice. The proportion being recycled depends on whether the discharged oil is within industry standards or not. This filtration system is adjustable in accordance with the quality of the cooking oil which is being filtered. This feature is lacking in many filtration systems, such as those disclosed in U.S. Pat. No. 5,597,601, U.S. Pat. No. 4,747,944, U.S. Pat. No. 3,667,613, U.S. Pat. No. 5,247,876, U.S. Pat. No. 3,107,601, U.S. Pat. No. 2,698,092, and U.S. Pat. No. 3,630,361.

Furthermore, the prior art fails to provide filtration apparatus in which a predetermined portion of the cooking oil is recycled to the filtration system before being discharged. For example, U.S. Pat. No. 4,747,944 discloses a filtration system in which filtrate is recirculated by being discharged into a vessel which contains unfiltered cooking fat or cooking oil. The mixture of partially-filtered oil is then returned to the filter. An obvious drawback of this system is the absence of any mechanism for controlling the proportion of the oil which is recycled to the filter. A second apparent limitation is the requirement of a vessel for mixing the liquid discharged from the filter with unfiltered liquid.

U.S. Pat. No. 6,365,214 discloses a cooking oil sponge in the form of an apparatus for absorbing, containing, immobilizing, transporting and disposing of quantities of used cooking oil, comprising decomposed organic matter and/or inorganic matter.

Prior art provides several methods for treating spent cooking oil with the aim of filtering food residuals, dewatering and reducing foaming (soap). For example, U.S. Pat. No. 4,764,384 describes a composition of silicates including a hydrated amorphous silica gel to adsorb free fatty acids, thereby reducing the combination of free fatty acids and metallic ions and the resulting soap. In U.S. Pat. No. 4,235,795, pumicite is admixed with used cooking oil as an adsorbent for free fatty acids. In U.S. Pat. No. 4,330,564, a chelating agent is admixed with the cooking oil to tie up the metal ions and prevent the combination of free fatty acids and metal ions and the resulting production of soap. In U.S. Pat. No. 3,231,390, a saponification process removes the metallic ions from used cooking oil as soap by filtration, using an adsorbent consisting of an alkaline earth metal carbonate or an alkaline earth metal oxide. These processes are effective in preventing the formation of soap and filtering food particles from the used cooking oil, but these processes do not decolor or deodorize the spent oil. To overcome those defects, U.S. Pat. No. 5,229,013 discloses a particulate hydrated filter material for use in treating edible glyceride oils contaminated resulting from the cooking of food. The filter media consist of a mixture of clay, silica and water. The silica is from the class consisting of metal silicates including magnesium silicate and calcium silicate, perlite, pumicite, rhyolite, volcanic ash, silica gel, vermiculite, and diatomaceous earth.

U.S. Pat. No. 5,597,600 describes a process for treating cooking oil which comprises contacting cooking oil with magnesium silicate and at least one alkali material, such as, for example, calcium hydroxide. The magnesium silicate and at least one alkali material are present in amounts effective to reduce the content of free fatty acids in the oil and permit reuse of the oil for cooking. Such method provides for improved extension of the life of the cooking oil employed in restaurant-type and industrial frying operations.

U.S. Pat. No. 6,187,355 describes a method for treatment and recovery of spent frying oils using combinations of adsorbents and antioxidants. A ternary mixture of adsorbents comprising calcium silicate, magnesium silicate and at least one of a porous rhyolitic material and silicon dioxide are used in effective amounts for treating frying oil to unexpectedly and significantly reduce free fatty acids of the treated used frying oil as well as improve total polar component, oil stability and color. Combinations of antioxidants can be included in the treated oil in effective amounts to provide unexpected, significant improvements in oil stability and service life of the treated used frying oil. The method provides unexpected improvements in used frying oil adsorptive and other properties, quality and service life such that the recovered frying oil can be reused.

Processes for treating used cooking oil include, employment of a composition of diatomite, synthetic calcium silicate hydrate, and synthetic magnesium silicate hydrate for reclaiming used oil as disclosed by U.S. Pat. No. 4,112,129; contacting used the cooking oil with a high surface area of at least 300 square meters per gram of amorphous synthetic magnesium silicate as disclosed by U.S. Pat. No. 4,681,768; and the use of magnesium silicate and at least one alkali material for reducing the content of free fatty acids in the oil or fat as disclosed by U.S. Pat. No. 5,597,600. In all these cases, the frying system is shut down periodically in order to remove the oil from the fryer to a batch treatment tank where a purifying material is mixed for a specified time and then removed by filtration. The oil then is ready to return to the fryer. In contrast, U.S. Pat. No. 6,368,648 discloses an automated system, for treating used cooking oil or fat that may be run continuously, thus providing for a more efficient process of treating used cooking oil. After the oil is treated, residual oil and the used purifying material may be removed from the filter apparatus by blowing gas through the filter apparatus.

In U.S. Pat. No. 6,210,732, an additive comprising a mixture of calcium silicate and citric acid is utilized for extending the useful life of the cooking oil by blending the calcium silicate with the citric acid, introducing the mixture to the cooking oil and allowing the mixture to mix in the oil through convection currents in the oil. The oil is filtered and the composition is added on a daily or other basis, dependent on use.

### SUMMARY OF THE INVENTION

To address the deficiencies of the prior art in rejuvenating, or treating, used cooking oil for repeated use, the present invention permits the repeated use of cooking, or frying, oil by introducing a mixture of granulated active carbons (GACs) and natural plant-based antioxidant into the used oil. For example, rejuvenation of used frying oil in residential uses is achieved by dipping a small package of a mixture of GACs produced from plant-waste and natural plant-based antioxidant following the cooking process. On a commercial or industrial scale, filtered used oil is deodorized, decolorized and rancidity is removed by a mixture of nut-based GACs and natural antioxidants for reuse or to rejuvenate portions of the frying oil during cooking.

Thus, it is an object of the present invention to rejuvenate used frying oil between reuses on a small scale to provide flavorful fried food products and to reduce smoke during frying at home.

It is a second object of the present invention to provide a convenient package that can be immersed in used frying oils to effectively decolorize and deodorize, remove phospholipids, soap, and oxidized matter on commercial and industrial scale to extend the useful life of frying oils and to preserve the quality of fried food products.

It is another object of the present invention to provide a filter media which excels in deodorizing used cooking oil and which imparts a superior flavor to products cooked with used cooking oil which has been filtered with that filter media.

It is a further object of the present invention to deodorize stored soybean oil before use or reuse.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

FIG. 1 illustrates an exemplary embodiment of the present invention employing a porous container with a mixture of an absorbent material and a natural antioxidant material, where the absorbent material is a matrix of plant-based granulated activated carbons.

FIG. 2 illustrates a chart of a method for employing the present invention including the use of a filtration step.

FIG. 3 illustrates yet another embodiment of the present invention employing a filtration device with an admixture of plant-based granulated activated carbons and a natural antioxidant material.

### DETAILED DESCRIPTION OF THE INVENTION

Although the prior art introduces a variety of approaches, the prior art fails to provide a simple, effective, and economical approach of extending the useful life of frying oil, while meeting FSIS guidelines. The present invention provides an effective and economical way to slow degradation of cooking, or frying oil, in order to extend the oil's usable life. In particular, the present invention addresses the unmet need of a simple apparatus or method for decolorization, deodorization, and deoxidization of used frying oil using natural ingredients derived from plants. Accordingly, the present invention enhances the quality of used frying oils with improved treating agents for the recovery and rejuvenation.

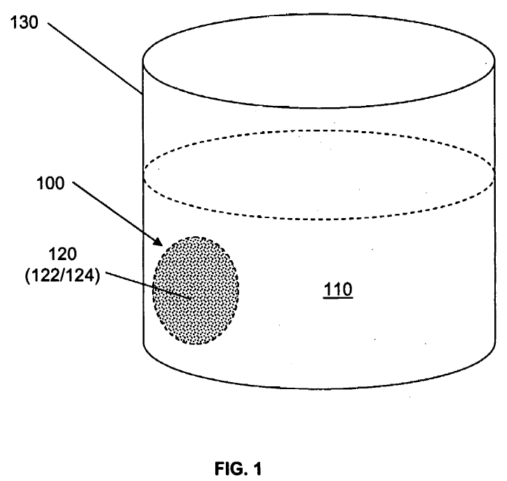

As illustrated in the exemplary embodiment of FIG. 1, a porous, heat-resistant container 100 is submerged, or otherwise positioned, in used cooking oil 110 which sits in oil vat 130. The container 100 holds a mixture 120 of an absorbent material 122 and a natural antioxidant material 124. The absorbent material 122 is a matrix of plant-based granulated activated carbons (GACs). In particular, about 80 percent by volume of the mixture 120 is the absorbent material 124, and about 20 percent by volume of the mixture 120 is the natural antioxidant material 122. The container 100 may be a porous, heat-resistant paper bag or a stainless steel infuser, though the container 100 is not limited to these materials. For large fast food frying operations, a large polylined bag can be used, for example. The rejuvenation process can be achieved by dropping the container 100, containing the GACs and antioxidants, in the hot oil after frying or cooking and covering the oil vat 130. The container 100 is left in the oil until the oil is reused. The mixture 120 removes the causes of undesirable changes in color, odor, and flavor. For soybean oil, the mixture deodorizes the oil before use or reuse.

The natural antioxidant material 124 may include, but is not limited to, citric acid (lemon peels), tartaric acid (tamarind), ascorbic acid, BHT, and the like in order to prevent rancidity.

Preferably, the absorbent material 122 includes activated plant-based carbons that have no toxic releases. Thus, the absorbent material 122 may include agricultural by-products, such as a combination of date pits, cherry pits, nutshells, and the like. The absorbent material 122 may take the form of specially designed GACs, solid miniature discs or pellets. Preferably, the absorbent material 122 includes GACs with large surface area. The physical, chemical, and surface properties of the GACs may differ for different oils and oil applications. Accordingly, a combination of absorbents may be required to scavenge odor profiles, ensuring that the absorbent material 122 has the surface areas and the porosities with optimal affinity to the particular odor agents and the color precursors.

The GACs production process is optimized to produce plant-based active carbons with high affinity for free fatty acids, oxidized fatty acids and other organics, especially those typically responsible for oil odors. The most suitable feedstock, such as nutshells of pecan, almond, and English walnut, is selected. Furthermore, the best pyrolysis/activation conditions, such as steam and phosphoric acid, are chosen for absorption of the olfactory signature of each food components. Plant-based GACs are similar to those currently produced by the USDA-ARS, Southern Regional Research Center (SRRC), New Orleans, La. or equivalent, and described in U.S. Pat. No. 6,033,573 and U.S. Pat. No. 6,537,947.

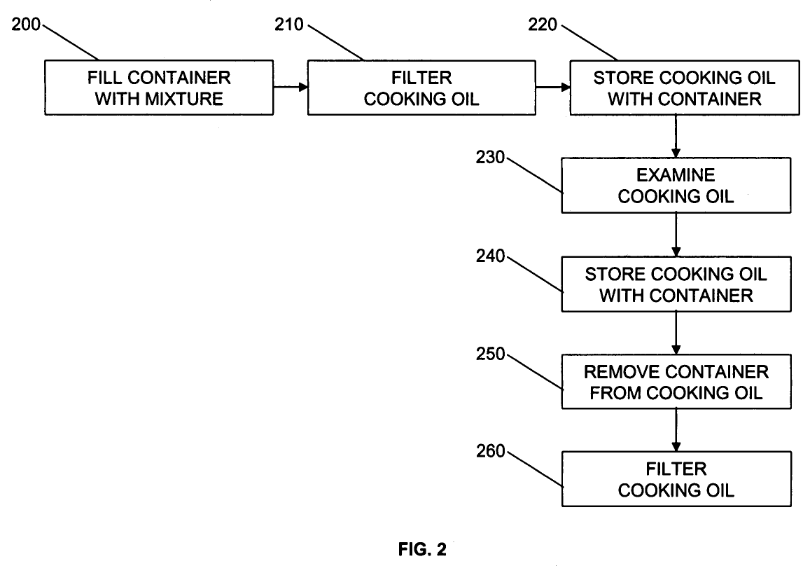

FIG. 2 illustrates the exemplary steps of treating used cooking oil for reuse. In particular, this method may be suitable for treating a small quantity of oil. In step 200, an empty porous container is filled with a mixture of plant-based granulated activated carbons and a natural antioxidant material. As an example, a container, resembling an empty teabag, is filled with a mixture, where 80 percent by volume of the mixture includes nutshell-based granulated activated carbons, and 20 percent by volume of the mixture includes lemon peels. The container can then be secured to prevent the mixture from escaping from the container.

In step 210, the used cooking oil is passed through a filter to remove food particles and solids. For instance, the used cooking oil can be poured through a strainer into a storage device.

In step 220, the porous container with the mixture is stored in the filtered cooking oil. For example, the mixture secured in a tea-bag like container is submerged in the filtered cooking oil, and the oil is stored with the bag until further use. Storing the used oil with the mixture removes the chemicals responsible for changes in color, aroma, and flavor, which filtration alone fails to achieve. By dipping the container in filtered used cooking oil, the dark brown color and the odor will be removed as well as the oxidized fatty acids.

FIG. 2 also illustrates subsequent optional steps in the method. In step 230, the cooking oil stored with the mixture in the container is examined. For instance, the color of the oil is examined visually to determine the level of decolorization achieved from storing the oil with the mixture. Additionally, the odor of the oil is examined by smell to determine the level of deodorization achieved from storing the oil with the mixture. In step 240, the mixture in the container is stored in the cooking oil for more time to achieve further decolorization and deodorization. In step 250, when acceptable decolorization and deodorization is achieved, the container with the mixture is removed from the oil. In step 260, the cooking oil is passed through a filter for a second time for further use of the oil.

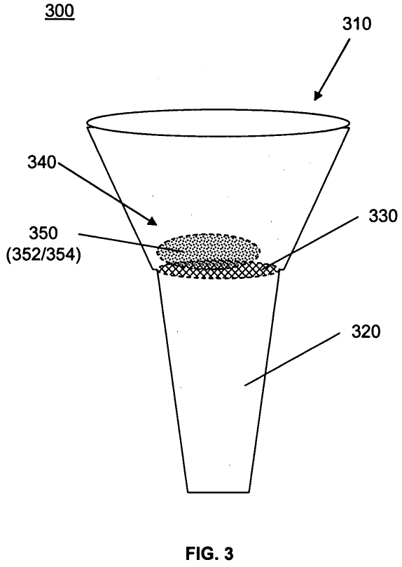

Another exemplary embodiment of the present invention is illustrated in FIG. 3. A device 300 has a funnel 310 with a narrow stem 320. A sieve 330 is provided in the funnel 310. Placed within the funnel 310 and positioned at the sieve 330 is a porous container 340 with an admixture 350 of plant-based granulated activated carbons 352 and a natural antioxidant material 354. Thus, the device 300 acts as a filtration device that filters food particulates and oxidized fats while also rejuvenating the used frying oil with the admixture 350.

While the present invention has been described in connection with a number of exemplary embodiments, and implementations, the present inventions are not so limited, but rather cover various modifications, and equivalent arrangements, which fall within the purview of prospective claims.

What is claimed is:

1. A device for decolorization, deodorization and deoxidization of cooking oil, said device comprising:
a porous, heat-resistant container positionable in said cooking oil; and
a mixture, in said container, comprising an absorbent material and a natural antioxidant material, said absorbent material comprising a matrix of plant-based granulated activated carbons.

2. The device according to claim 1, wherein about 80 percent by volume of said mixture is said absorbent material, and wherein about 20 percent by volume of said mixture is said antioxidant material.

3. The device according to claim 1, wherein said container is a paper bag.

4. The device according to claim 1, wherein said container is a stainless steel infuser.

5. The device according to claim 1, wherein said cooking oil is soybean oil.

6. A method for treating used cooking oil for reuse, said method comprising:
filling a porous container with a mixture of plant-based granulated activated carbons and a natural antioxidant material;
filtering used oil through a filter to remove food particulates and solids; and
storing said porous container with said mixture in said oil.

7. The method according to claim 6, wherein said plant-based granulated activated carbons comprises nutshell based granulated activated carbons, and wherein said natural antioxidant material comprises lemon peel.

8. The method according to claim 6, wherein said plant-based granulated activated carbons are about 80 percent by volume of said mixture, and wherein said natural oxidant material is about 20 percent by volume of said mixture.

9. The method according to claim 6, wherein said porous container is an empty teabag.

10. The method according to claim 6, further comprising:
examining the color of said used oil to determine decolorization;
examining the odor of said used oil to determine deodorization;
storing said porous container with said mixture in said oil for more time for further decolorization or deodorization;
removing said porous container from said used oil; and
filtering used oil through said strainer for further use of said oil.

11. A device for filtering food particulates and oxidized fats from used frying oil, said device comprising:
a funnel with a narrow stem;
a sieve to screen out food particulates and solids in said funnel; and
a container positioned in said funnel, said container being filled with an admixture of plant-based granulated activated carbons and a natural antioxidant material.
